(19) United States
(12) Patent Application Publication
(10) Pub. No.: US 2012/0050101 A1
(43) Pub. Date: Mar. 1, 2012

(54) PERSONAL LOCATOR DEVICE

(76) Inventor: James D. Whiteman, Highland Heights, OH (US)

(21) Appl. No.: 13/219,889

(22) Filed: Aug. 29, 2011

Related U.S. Application Data
(60) Provisional application No. 61/378,018, filed on Aug. 30, 2010.

(51) Int. Cl. G01S 19/48; G01C 21/00; G01S 19/14

(52) U.S. Cl. 342/357.31; 342/357.52; 701/519

(57) ABSTRACT

Some embodiments may relate to a location monitoring system and/or method. Embodiments may include a plurality of locator units, each adapted to be worn by a living subject. The locator units may be adapted to communicate with a host computer through the Internet, and/or receive location data signals from a plurality of location signal sources including one or more of a Global Positioning System satellite signal, a Global Navigation Satellite System signal, a broadcast television signal, a broadcast radio signal, a radar signal, a cellular telephone signal, and/or a wireless networking signal. A system embodiment of the invention may include a means for signaling a particular locator unit to search for location signals. A host may be adapted to receive location data from each of the plurality of locator units and to relay the location data through the Internet to other Internet-enabled devices.

### REFERENCE TO RELATED APPLICATIONS

This patent application claims priority to U.S. Provisional Patent Application No. 61/378,018 filed on Aug. 30, 2010 and now pending, which is incorporated herein by reference in its entirety.

### BACKGROUND OF THE INVENTION

1. Field of the Invention

Embodiments of the invention relate to methods and devices for determining the position of a wearer, such as a child or other living subject, of a personal positioning device.

2. Description of the Related Art

It is known in the art to use location data sources to calculate a location. For example, the art includes devices that use Global Positioning System satellite signals to locate a device that can be worn like a wrist watch. Similar devices include GPS enabled shoes. It is also well known that GPS signals are relatively low-power signals and are significantly attenuated inside buildings, for instance, which may render the signal unusable. Furthermore, when these prior devices are outside the range of available GPS signals they are unable to operate.

What is needed is a device and/or method that is capable of performing geo-location operations inside buildings or in other locations where GPS signals are too weak or too heavily attenuated to be useful. Some embodiments of the present invention may include one or more improvements over the prior art.

### SUMMARY OF THE INVENTION

Embodiments of the invention may include a location monitoring system, comprising: A plurality of locator units, each adapted to be worn by a living subject, and adapted to be in electronic data networking communication with each other on an ad-hoc basis, each locator unit being adapted to communicate with a host computer through the internet, and each locator unit being adapted to receive location data signals from a plurality of location signal sources including one or more of a global positioning system satellite signal, a global navigation satellite system signal, a broadcast television signal, a broadcast radio signal, a radar signal, a cellular telephone signal, and/or a wireless networking signal; a system activation means for signaling a particular locator unit of the plurality of locator units to search for location signals, calculate location from said signals, and report a location back to the host computer; and the host computer being adapted to receive location data from each of the plurality of locator units and to relay the location data through the internet to other internet-enabled devices.

According to some embodiments the plurality of locator units defines a form selected from one or more of a wrist watch, a lanyard, a necklace, a bracelet, an ankle bracelet, a collar, a tag, or a wearable article.

According to some embodiments each of the plurality of locator units further comprise at least one antenna adapted to send and/or receive one or more wireless signals including a global positioning system satellite signal, a global navigation satellite system signal, a broadcast television signal, a broadcast radio signal, a radar signal, a cellular telephone signal, or a wireless networking signal.

According to some embodiments each of the plurality of locator units further comprise an engine selected from one or more of a global positioning system engine or a broadcast signal engine, wherein the engine is adapted to receive one or more location signals from the antenna and process the one or more location signals according to predefined processing steps.

According to some embodiments the global positioning system engine and/or the broadcast signal engine are adapted to assess location signal quality according to predefined criteria and either accept or reject the location signal accordingly.

According to some embodiments each of the plurality of locator units further comprise a digital clock in electronic communication with one or more of the global positioning system engine or the broadcast signal engine, wherein the global positioning system engine and/or the broadcast signal engine are adapted to use an output of the digital clock to determine a travel time of an accepted location signal from a location signal source to the locator unit.

According to some embodiments each of the plurality of locator units further comprises a microprocessor in electronic data communication with one or more of the global positioning system engine or the broadcast signal engine and adapted to perform calculations on data received from the global positioning system engine or the broadcast signal engine, wherein the calculations include calculating a position from location signals.

According to some embodiments each of the plurality of locator units further comprises a volatile memory in data communication with the microprocessor and adapted to temporarily store predetermined data received from the microprocessor, wherein the data includes a position communicated from the microprocessor.

According to some embodiments each of the plurality of locator units further comprises a data link selected from one or more of a radio frequency data link or a cellular data link, wherein the one or more data links are adapted to communicate electronically with the remote host computer and to wirelessly transmit position data from the locator unit to the remote host computer through the internet.

According to some embodiments a process for monitoring the location of a living subject comprising the steps of: fixing a locator unit to the living subject.

Providing a means for a host computer to receive an activation request from a remote location; the host computer identifying a particular locator unit to be activated; the host computer sending a wake-up signal to the identified locator unit; the locator unit searching for transmitting location signal sources and identifying location signals emitted therefrom; the locator unit determining whether identified location signals are acceptable, and accepting or rejecting location signals accordingly; calculating a position using one or more accepted location signals; and the host computer transmitting the calculated position to one or more network enabled devices.

According to some embodiments the step of providing a means for receiving an activation request includes providing a means for receiving an SMS message, an email, a telephone call, or manual entry of a request by a telephone operator.

According to some embodiments the step of sending a wake-up signal includes routing the signal through one or more of the internet, a cellular telephone network, a wireless local area network, or an ad-hoc network.

According to some embodiments the step of determining whether identified location signals are acceptable includes evaluating one or more of signal strength, noise level, or signal-to-noise ratio.

According to some embodiments the step of calculating a position includes performing the calculation on the locator unit, or on the host computer.

Some embodiments further comprise the step of the locator unit communicating the calculated position to the host computer.

According to some embodiments the step of transmitting the calculated position to one or more network enabled devices further comprises transmitting one or more of cartographic coordinates, or a map.

According to some embodiments a location monitoring system, comprising: a means for receiving a system activation message, generating a system activation signal in response to receiving the system activation message and communicating the system activation signal to a locator unit, wherein the system activation signal causes the locator unit to become active; the locator unit being adapted to be worn by a living subject, the unit comprising one or more of a watch, a lanyard, a necklace, an ankle bracelet, a bracelet, a collar, a tag, or a wearable article; a means for receiving a location signal from at least one location signal source selected from one or more of a global positioning system satellite signal, a global navigation satellite system signal, a broadcast television signal, a cellular telephone signal, a radio signal, or a wireless networking signal; a means for assessing the quality of location signals received, and accepting or rejecting location signals according to predefined criteria; a means for calculating a position according to one or more accepted location signals; a means for communicating the position to a host computer; a means for communicating the position from the host computer to a network enabled device; and a means for directing one or more individuals to the position.

According to some embodiments the means for receiving a system activation message comprises a means for receiving an SMS message, an email, a telephone call, or manual entry of a request by a telephone operator.

According to some embodiments the means for calculating a position can be located on a locator unit or on a remote host computer.

According to some embodiments the means for communicating the position to a host computer includes one or more of a means for connecting to the internet, linking to a cellular telephone network, linking to a wireless local area network, or linking to an ad-hoc network.

### BRIEF DESCRIPTION OF THE DRAWINGS

The various features and advantages of the present invention may be more readily understood with reference to the following detailed description taken in conjunction with the accompanying drawings, described by way of example, and wherein like reference numerals designate like structural elements, and in which:

FIG. 1 is a schematic diagram of an embodiment;

FIG. 2 is a flowchart illustrating a process of activating a locator unit;

FIG. 3 is a flowchart illustrating a process of calculating a position;

FIG. 4 is a schematic diagram showing the relationships among a plurality of interconnected locator units;

FIG. 5 is a flowchart illustrating a process of using position data to dispatch personnel;

FIG. 6 is a schematic diagram illustrating the flow of data through a host computer; and

FIG. 7 is a schematic diagram illustrating components of a locator unit according to one embodiment.

### DETAILED DESCRIPTION

Embodiments of the present invention may comprise a system for locating the wearer of a locator device. For instance, in one embodiment a system includes a wearable locator device adapted to communicate with a remote computer through, for instance, a cellular data link, and with one or more location signal sources. According to such embodiments the location signal may be received by the locator device which may calculate a relative position using the received signal data. Alternatively, the locator device may transmit the received data to a host computer which calculates a relative position using the transmitted data. In some embodiments the relative position can be converted to cartographic coordinates, plotted on a map and/or transmitted to an observer such as, without limitation, a police department, fire department, school or parent.

In one embodiment, a locator device may be worn by a human or non-human subject, the locator device normally being in a sleep state when not monitoring a locator signal(s). If a parent, for instance, wishes to learn the position of the subject the parent can cause a wake-up signal to be transmitted to the locator unit, which results in the locator unit becoming capable of receiving location data from one or more location data sources. In one embodiment, the locator device takes the form of a wrist watch; however, one of skill in the art will recognize that any of a variety of convenient wearable forms may be appropriate. For instance, other suitable forms include lanyards, necklaces, collars, tags, bracelets, ankle bracelets, ear rings, shoes, articles of clothing, or other items that can be worn. Accordingly, a step of fixing a locator unit to a living subject can include the ordinary processes of putting on such items.

According to some embodiments a locator unit may assess signal quality and reject signals that do not meet certain predefined criteria indicating, for instance, signal strength, signal-to-noise ratio and the like. Additionally, or alternatively, some embodiments may transmit the location signal data to a remote computer that assesses the location signal according to predefined criteria such as signal strength, signal-to-noise ratio and the like.

Regardless of whether the locator unit or a remote computer assesses location signal quality, if a location signal is determined to be unacceptable, some embodiments search for an alternative location signal. The process of signal assessment, rejection, and search for an alternative may continue until an acceptable location signal is identified or all signal options are exhausted. Furthermore, some embodiments may enable locator units to search for other nearby locator units and to network and/or swarm with each other. Such networks may include mobile ad hoc networks, i.e. MANET, which are not fixed to a specific location and are able to configure themselves on the fly. For instance, a locator unit may establish data communication with a remote host computer directly or through one or more nearby units that have successfully established data communication with the host computer. Similarly, a locator unit that is unable to identify an acceptable location signal may be able to cooperate with one or more nearby locator units that have identified an acceptable signal, and to use such signal to approximate its own location.

According to some embodiments, suitable location signal sources can include, without limitation, Global Positioning System (GPS) satellite signals, Global Navigation Satellite Systems (GNSS), and/or broadcast signals such as TV signals (VHF and UHF), cellular signals, radio signals (VLF, LF, MF and HF), NIST Radio Station WWVB, signals in the SHF, EHF, FIR, MIR, NIR and visible, radar signals, WiMax, Bluetooth, WiFi and custom RF signals. With specific regard to broadcast signals, known positioning methods and devices can be applied to calculate position from broadcast signals such as, without limitation, intelligent spectrum sensing and cognitive RF signal positioning methods and related devices.

Locator units may communicate with one or more remote host computers through any of a variety of means. For instance, in some embodiments a locator device is in data communication with a remote host through a cellular data link, or a WiFi data link. Such means of communication may or may not be routed through the Internet.

According to embodiments of the invention, a remote host computer may perform a variety of functions including, without limitation, assessing the quality of a location signal; accepting or rejecting a location signal; calculating the position of a locator unit; calculating cartographic coordinates indicating a position; plotting a calculated position on a map; relaying position data, cartographic coordinates, and/or map data to a third party such as a first responder, parent, or school.

Some embodiments may include one or more power sources. For instance, embodiments may include one or more of a battery, photovoltaic cell, and/or a means for harvesting kinetic energy from the wearer. Means for harvesting kinetic energy may include one or more of resonant generators, piezoelectric generators, wafer-scale electromagnetic harvesting means, macro-scale electromagnetic harvesting means, electrostatic energy harvesting means, and energy harvesting means involving magenetostrictive materials. Some electrostatic energy harvesting means can include one or more of in-plane overlap varying means, in-plane gap closing means, out-of-plane gap closing means, Coulomb force parametric means, and/or charged electrets means.

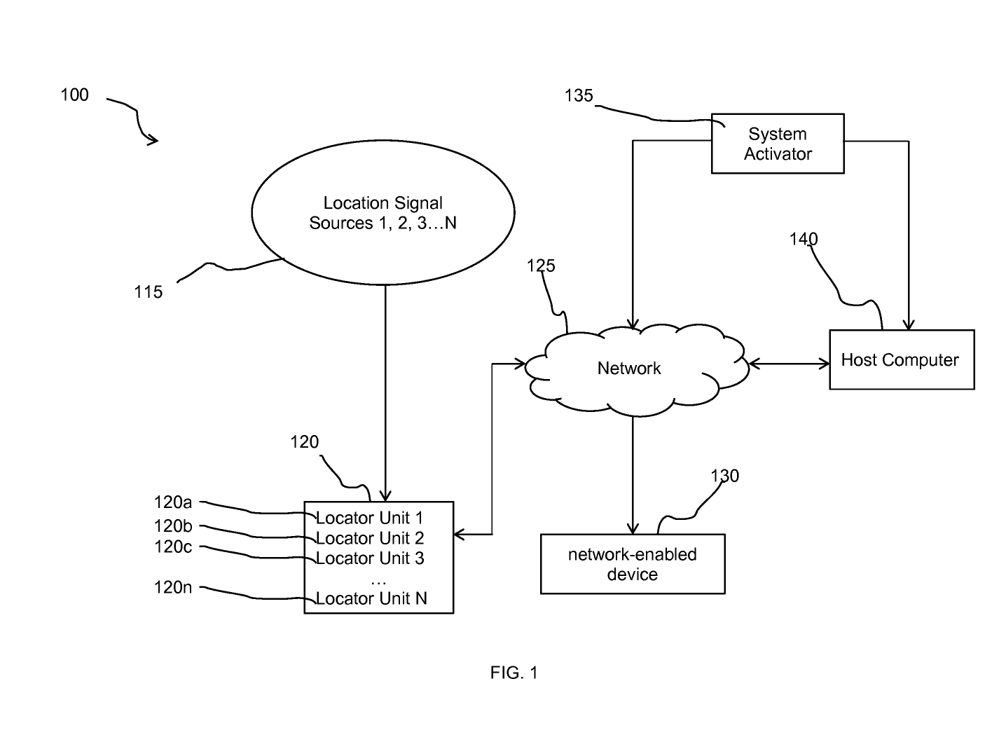

Referring now to the drawings wherein the showings are for purposes of illustrating embodiments of the invention only and not for purposes of limiting the same, FIG. 1 is a schematic diagram of an embodiment 100. As shown in FIG. 1, a system 100 according to an embodiment includes a plurality of locator units 120 such as, without limitation, a wrist watch or other wearable item. The locator units 120 are in bidirectional data communication with a network 125. The network 125 can include one or more of a telecommunications network, the Internet, a local area network, and/or any of a wide variety of suitable means for transferring data to and from a remote location. The plurality of locator units 120 are also in one-way data communication with one or more location signal sources 115 such as navigation satellites, or broadcast signals as previously discussed herein.

The embodiment of FIG. 1 further comprises a remote host computer 140 which is adapted to form a data communication link with the plurality of locator units 120 through the network 125. As a non-limiting example, a system activator 135, e.g. a person activating the system, may communicate with the host computer 140 directly or through the network 125 via one or more of a cellular phone, hardwired phone, and/or internet connection. Accordingly, a system activator 135 may send a message to the host computer 140 requesting location services. The host computer 140 may then communicate a wake-up and/or activation signal to a particular locator unit, e.g. 120a causing the locator unit 120a to search for suitable location signal sources 115. The locator unit may additionally or alternatively search for location signal sources 115 through an ad-hoc network of other locator units, e.g. 120b, 120c . . . 120n. If a suitable location signal source is identified, the system 100 can accept the location signal data and calculate a position of the locator unit accordingly. The calculated position may be rendered, for instance, in the form of a map or may otherwise be presented or relayed to one or more network enabled devices 130. Such network enabled devices 130 may be in the possession of a parent, school or first responders thus enabling such individuals to locate the wearer of the locator device 120a.

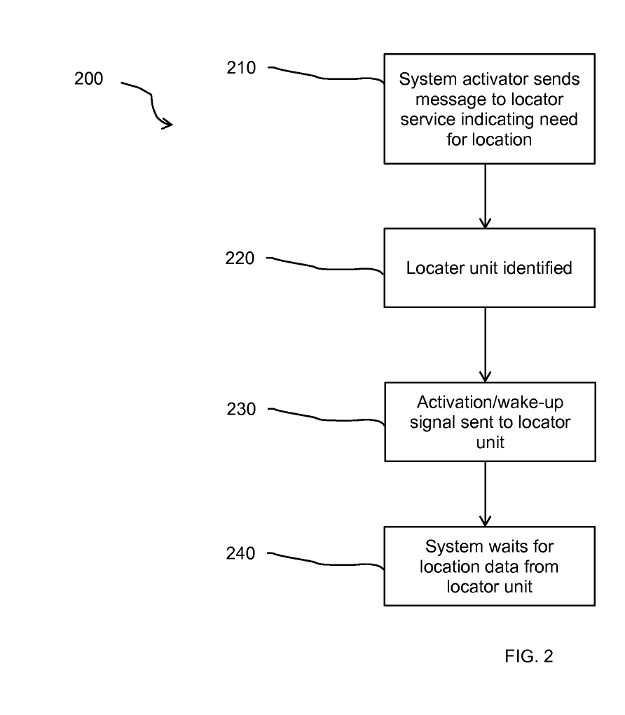

FIG. 2 is a flowchart showing a process 200 of activating a locator unit. According to process 200 in step 210 a system activator, such as a parent, communicates with a locator service requesting the location of a particular locator unit. Any of a wide variety of communication means may be used for this purpose including, without limitation, SMS messaging, email, and/or telephone. Predetermined identifying information is passed from the system activator to the locator service so that the service can identify 220 the particular locator unit. The service then sends 230 a wake-up and/or activation signal to the identified locator unit. The system then waits 240 for the locator unit to wake-up and either relay location signal data, report location data, or otherwise send a signal indicating its status.

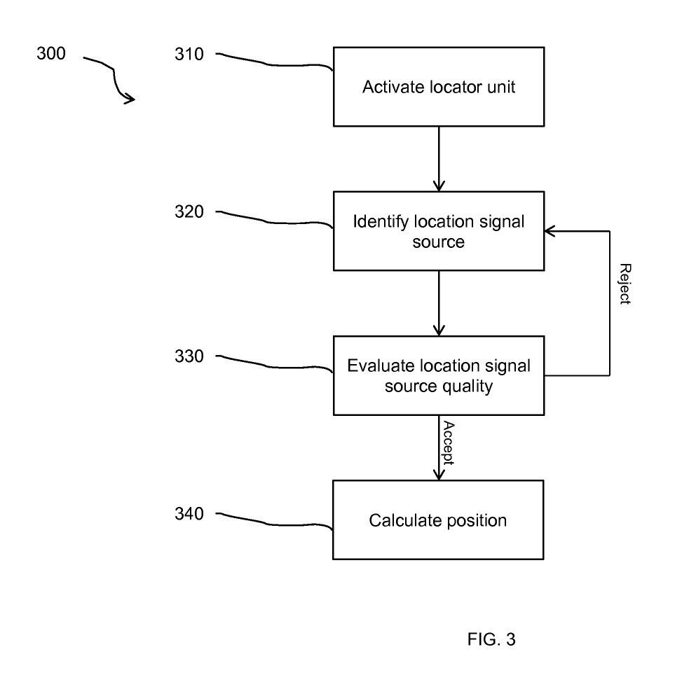

FIG. 3 is a flowchart showing a process 300 for identifying suitable location signal sources. According to the embodiment of FIG. 3 such a process can include activating 310 a particular locator unit previously identified by the system. The locator unit then searches for and identifies 320 a location signal source. The signal quality is evaluated 330 and the signal source is accepted or rejected accordingly. If the signal source is rejected then the process returns to step 320 and an alternative location signal source is identified. This cycle can continue until at least one suitable location signal source is identified. When at least one suitable signal is identified the location signal data is accepted and a position of the locator device is calculated 340.

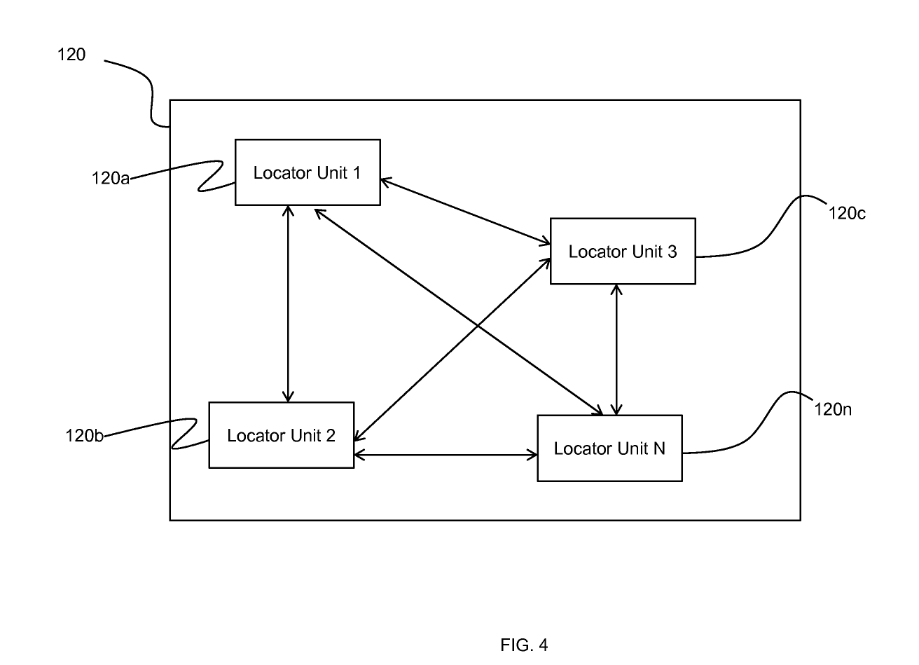

FIG. 4 is a schematic diagram showing logical relationships between locator devices 120a, 120b, 120c . . . 120N from FIG. 1, which form an ad-hoc network. As shown, each locator device 120a, 120b, 120c . . . 120N has bidirectional network access to each of the other locator devices. In some embodiments, the locator devices 120a, 120b, 120c . . . 120N may use this connectivity to pass data to a host computer through one or a plurality of the other locator devices. In some embodiments, the connectivity relationships shown in FIG. 4 may be used in addition to direct communication with navigation satellites and/or broadcast signals. However, in some embodiments the relationships shown in FIG. 4 may be used as an alternative or back-up to direct communication. For example, while locator devices 120a, 120b and 120c may be out of range of a location signal, locator device 120N may be within range of such a signal, and may also be in wireless ad-hoc communication with devices 120a, 120b and/or 120c. Thus, locator device 120N may serve as a signal relay means for devices 120a, 120b and 120c. Similarly, 120N may be within range of a wireless data link and may thus serve as a signal relay for passing data between devices 120a, 120b and 120c and a host computer.

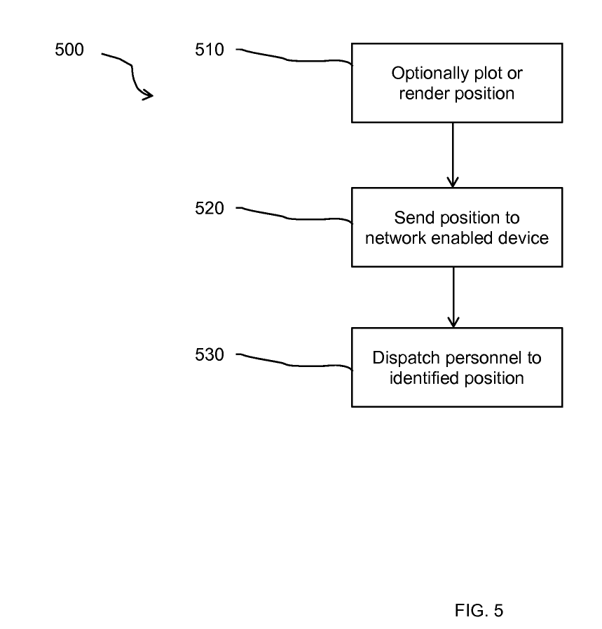

FIG. 5 is a flowchart diagram showing a process 500 that may be applied to position data after a position has been calculated. According to FIG. 5 a process can include the optional step of plotting or rendering 510 a calculated position on, for instance, a map. In step 520 of the process 500, the plot or rendering can be forwarded to a network enabled device. Such devices can include internet enabled devices such as one or more of smart phones, personal digital assistants (PDAs), tablet computers, and/or personal computers. One of skill in the art will appreciate that rather than sending a plot or rendering, a host computer 140 may instead send data that can be plotted or rendered by a recipient network enabled device 130. Accordingly, personnel such as first responders can be dispatched to the calculated position in response to data received by the network enabled device 130.

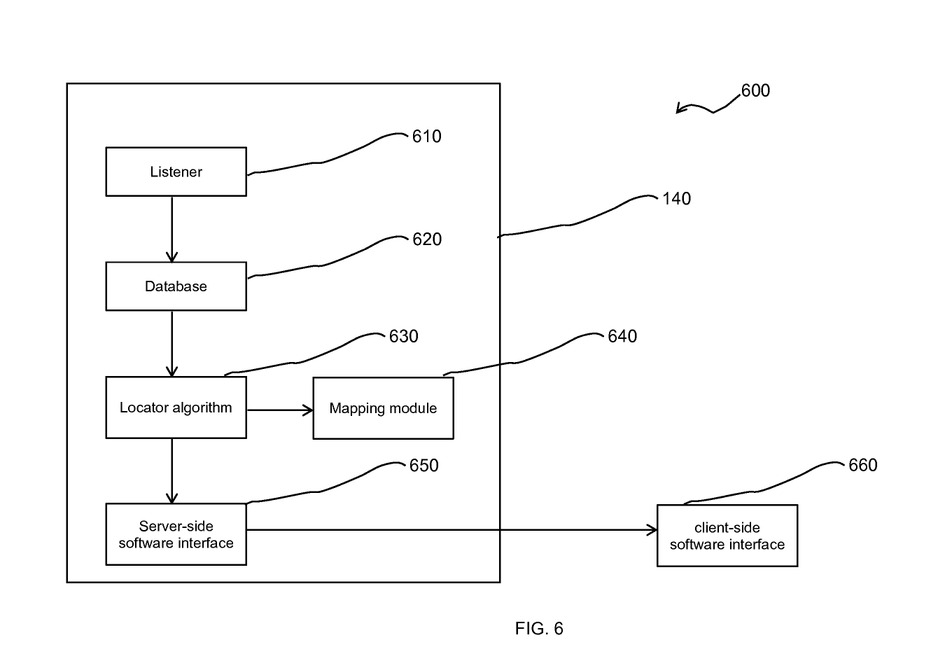

FIG. 6 is a schematic diagram of a software architecture 600 that may be suitable for a host computer 140. According to FIG. 6 a listener module 610 may receive a message requesting activation of a locator unit, and may additionally receive location data from the locator unit. In some embodiments a listener module may receive SMS or other suitable messages from, for example, a parent or other individual reporting a missing child. Further, according to the process 600 shown in FIG. 6, messages received by a host computer 140 may be recorded 620 in a database along with data identifying particular locator modules and associating them with particular wearers and/or subscribers. A locator algorithm may be applied 630 to calculate a position of a locator unit based upon location data received from the locator unit. An architecture 600 may also include a mapping module 640 for plotting cartographic coordinates on a map. Alternatively, a mapping module 640 may include a link to an external mapping service such as Google Maps®, MapQuest®, or similar services which generate a map indicating a calculated position on the map. An architecture 600 may include a server-side interface 650 for transmitting data to remote client applications 660.

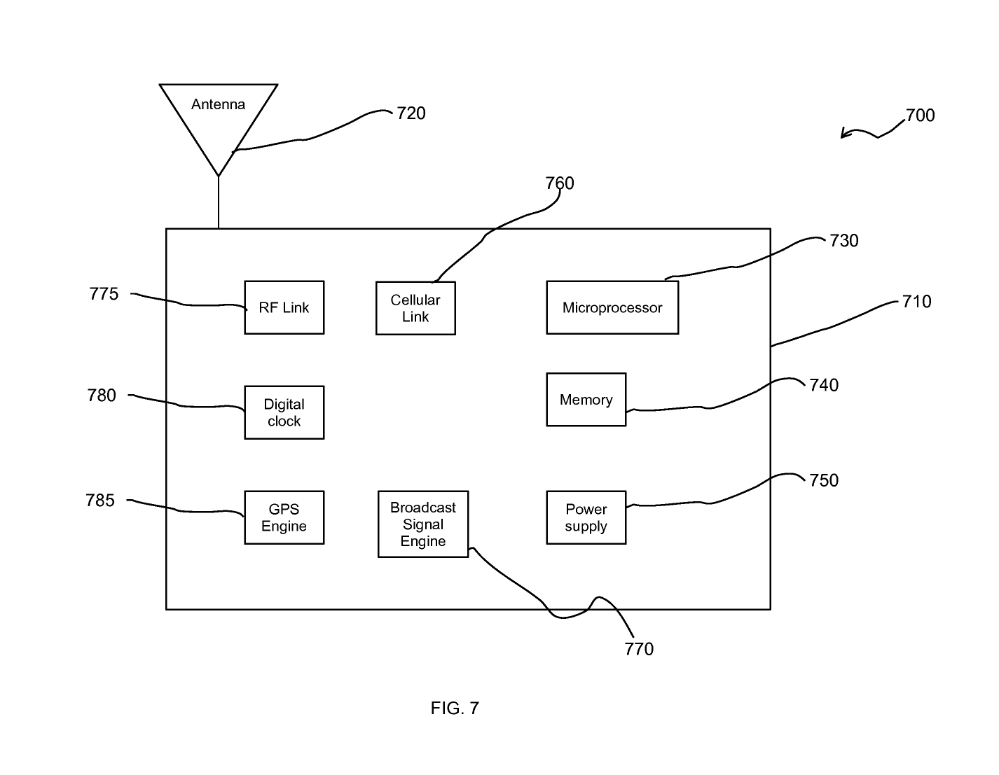

FIG. 7 is a block diagram showing components of a locator unit 700 according to one embodiment. As shown in FIG. 7, a locator unit 700 can include a chassis 710 for containing components in a unitary form. An embodiment can also include an antenna 720 for sending and/or receiving wireless signals such as, but not limited to, location signals and/or data communication signals. A microprocessor 730 may be included to perform any of a wide variety of on-board calculations including, without limitation, location signal quality assessments and/or calculation of a location from location signal data. A locator unit 700 may further include a memory 740 for temporarily storing any of a wide variety of data including, without limitation, location coordinates, system status or environment variables, or other data suited to volatile storage. A power supply 750 according to FIG. 7 may include a single power source or a plurality of power sources. For instance, a power supply 750 may include one or more of a rechargeable or disposable battery, a photovoltaic cell, or a means for harvesting kinetic energy from the wearer as described herein. Furthermore, a power supply 750 may include electronic components such as transformers, resistors, rectifiers, etc. for conditioning electrical power.

With continuing reference to FIG. 7, a locator unit 700 can include a cellular link 760 and/or an RF link 775 for forming a data communication link to a network and/or to other locator units through, for instance, an ad-hoc network. Such data communication links can be used, for instance, to communicate with a host computer 140. A locator unit 700 may further include a GPS engine 785 and/or a broadcast signal engine 770 which are adapted to receive location signal data from the antenna 720 and perform predetermined operations on the signal before communicating the results of such operations to a host computer 140. Finally, a locator unit 700 may include a digital clock 780, for instance, for synchronizing with an atomic clock of a GPS satellite or for otherwise establishing a time delay between sending and receiving a location signal. Additionally, the digital clock 780 may be used, for instance, to modulate a data stream into an RF or other signal.

Finally, while much of the foregoing description focuses on devices for locating lost children, it will be understood to those skilled in the art that embodiments of the invention may also be applied to tracking the location of elderly persons, disabled or mentally impaired persons, pets, wild animals, or even inanimate objects such as valuable possessions.

Illustrative embodiments having been described hereinabove, it will be apparent to those skilled in the art that the above methods and apparatuses may incorporate changes and modifications without departing from the general scope of this invention. It is intended to include all such modifications and alterations insofar as they come within the scope of the appended claims or the equivalents thereof.

Having thus described the invention, it is now claimed:

1. A location monitoring system, comprising:
a plurality of locator units, each adapted to be worn by a living subject, and adapted to be in electronic data networking communication with each other on an ad-hoc basis, each locator unit being adapted to communicate with a host computer through the Internet, and each locator unit being adapted to receive location data signals from a plurality of location signal sources including one or more of a Global Positioning System satellite signal, a Global Navigation Satellite System signal, a broadcast television signal, a broadcast radio signal, a radar signal, a cellular telephone signal, and/or a wireless networking signal;
a system activation means for signaling a particular locator unit of the plurality of locator units to search for location signals, calculate location from said signals, and report a location back to the host computer; and
the host computer being adapted to receive location data from each of the plurality of locator units and to relay the location data through the Internet to other Internet-enabled devices.

2. The system of claim 1, wherein the plurality of locator units defines a form selected from one or more of a wrist watch, a lanyard, a necklace, a bracelet, an ankle bracelet, a collar, a tag, or a wearable article.

3. The system of claim 1, wherein each of the plurality of locator units further comprise at least one antenna adapted to send and/or receive one or more wireless signals including a Global Positioning System satellite signal, a Global Navigation Satellite System signal, a broadcast television signal, a broadcast radio signal, a radar signal, a cellular telephone signal, or a wireless networking signal.

4. The system of claim 3, wherein each of the plurality of locator units further comprise an engine selected from one or more of a Global Positioning System engine or a broadcast signal engine, wherein the engine is adapted to receive one or more location signals from the antenna and process the one or more location signals according to predefined processing steps.

5. The system of claim 4, wherein the Global Positioning System engine and/or the broadcast signal engine are adapted to assess location signal quality according to predefined criteria and either accept or reject the location signal accordingly.

6. The system of claim 5, wherein each of the plurality of locator units further comprise a digital clock in electronic communication with one or more of the Global Positioning System engine or the broadcast signal engine, wherein the Global Positioning System engine and/or the broadcast signal engine are adapted to use an output of the digital clock to determine a travel time of an accepted location signal from a location signal source to the locator unit.

7. The system of claim 6, wherein each of the plurality of locator units further comprises a microprocessor in electronic data communication with one or more of the Global Positioning System engine or the broadcast signal engine and adapted to perform calculations on data received from the Global Positioning System engine or the broadcast signal engine, wherein the calculations include calculating a position from location signals.

8. The system of claim 7, wherein each of the plurality of locator units further comprises a volatile memory in data communication with the microprocessor and adapted to temporarily store predetermined data received from the microprocessor, wherein the data includes a position communicated from the microprocessor.

9. The system of claim 8, wherein each of the plurality of locator units further comprises a data link selected from one or more of a radio frequency data link or a cellular data link, wherein the one or more data links are adapted to communicate electronically with the remote host computer and to wirelessly transmit position data from the locator unit to the remote host computer through the Internet.

10. A process for monitoring the location of a living subject comprising the steps of:
fixing a locator unit to the living subject;
providing a means for a host computer to receive an activation request from a remote location;
the host computer identifying a particular locator unit to be activated;
the host computer sending a wake-up signal to the identified locator unit;
the locator unit searching for transmitting location signal sources and identifying location signals emitted therefrom;
the locator unit determining whether identified location signals are acceptable, and accepting or rejecting location signals accordingly;
calculating a position using one or more accepted location signals; and
the host computer transmitting the calculated position to one or more network enabled devices.

11. The process of claim 10, wherein the step of providing a means for receiving an activation request includes providing a means for receiving an SMS message, an email, a telephone call, or manual entry of a request by a telephone operator.

12. The process of claim 10, wherein the step of sending a wake-up signal includes routing the signal through one or more of the Internet, a cellular telephone network, a wireless local area network, or an ad-hoc network.

13. The process of claim 10, wherein the step of determining whether identified location signals are acceptable includes evaluating one or more of signal strength, noise level, or signal-to-noise ratio.

14. The process of claim 10, wherein the step of calculating a position includes performing the calculation on the locator unit, or on the host computer.

15. The process of claim 11 further comprising the step of the locator unit communicating the calculated position to the host computer.

16. The process of claim 10, wherein the step of transmitting the calculated position to one or more network enabled devices further comprises transmitting one or more of cartographic coordinates, or a map.

17. A location monitoring system, comprising:
a means for receiving a system activation message, generating a system activation signal in response to receiving the system activation message and communicating the system activation signal to a locator unit, wherein the system activation signal causes the locator unit to become active;
the locator unit being adapted to be worn by a living subject, the unit comprising one or more of a watch, a lanyard, a necklace, an ankle bracelet, a bracelet, a collar, a tag, or a wearable article;
a means for receiving a location signal from at least one location signal source selected from one or more of a Global Positioning System satellite signal, a Global Navigation Satellite System signal, a broadcast television signal, a cellular telephone signal, a radio signal, or a wireless networking signal;
a means for assessing the quality of location signals received, and accepting or rejecting location signals according to predefined criteria;
a means for calculating a position according to one or more accepted location signals;
a means for communicating the position to a host computer;
a means for communicating the position from the host computer to a network enabled device; and
a means for directing one or more individuals to the position.

18. The system of claim 17, wherein the means for receiving a system activation message comprises a means for receiving an SMS message, an email, a telephone call, or manual entry of a request by a telephone operator.

19. The system of claim 17, wherein the means for calculating a position can be located on a locator unit or on a remote host computer.

20. The system of claim 17, wherein the means for communicating the position to a host computer includes one or more of a means for connecting to the Internet, linking to a cellular telephone network, linking to a wireless local area network, or linking to an ad-hoc network.
